(19) United States
(12) Patent Application Publication
(10) Pub. No.: US 2019/0392467 A1
(43) Pub. Date: Dec. 26, 2019

(54) SYSTEM AND METHOD FOR INTELLIGENT DIGITAL SUPPLY AND DEMAND PRICING

(71) Applicant: Walmart Apollo, LLC, Bentonville, AR (US)

(72) Inventors: John J. O'BRIEN, Farmington, AR (US); Donald R. HIGH, Noel, MO (US); Brian MCHALE, Oldham (GB)

(73) Assignee: Walmart Apollo, LLC, Bentonville, AR (US)

(21) Appl. No.: 16/451,155

(22) Filed: Jun. 25, 2019

Related U.S. Application Data
(60) Provisional application No. 62/689,625, filed on Jun. 25, 2018.

(51) Int. Cl. G06Q 30/02; G06Q 10/08; G06Q 10/06

(52) U.S. Cl. CPC G06Q 30/0206; G06Q 20/20; G06Q 10/06315; G06Q 10/087

(57) ABSTRACT

A system includes a product inventory engine (PIE) module and an intelligent pricing engine (IPE) module. The PIE module is configured to: receive data on an inventory of an item from one or more scanning devices; receive supply data for the item in a specified period of time; and determine an inventory level of the item based on the data and the supply data. The IPE module is configured to: receive a set of rules regulating the item; generate a decision on a price change for the item based on the inventory level of the item and the set of rules; and send the decision to one or more entities.

### CROSS REFERENCE TO RELATED APPLICATION

This patent application claims the priority to U.S. Provisional Application Ser. No. 62/689,625, filed Jun. 25, 2018, the contents of which is incorporated by reference herein.

### BACKGROUND

### 1. Technical Field

The present disclosure relates to pricing technology, and more specifically to systems and methods for intelligent digital supply and demand pricing.

### 2. Introduction

A pricing strategy on a product may impact a consumer's decision on whether or not to purchase the product. A wide range of pricing strategies may be used when selling a product, for example, maximizing profitability, preventing an existing market from new entrants, increasing market share within a market or entering a new market. With the advent of digital shelf technology being closely integrated into a business's operation (e.g., a retail store), an opportunity may emerge for a business to tune its pricing strategy in ways that the business has never been capable of Thus, opportunities may exist to leverage the capabilities of this digital shelf technology to improve a business to the fullest extent.

There is a need for systems and methods for intelligent inventory and supply control systems.

### SUMMARY

A system configured as disclosed herein can include: a product inventory engine (PIE) module and an intelligent pricing engine (IPE) module. The PIE module is configured to: receive data on an inventory of an item from one or more scanning devices; receive supply data for the item in a specified period of time; and determine an inventory level of the item based on the data and the supply data. The IPE module is configured to: receive a set of rules regulating the item; generate a decision on a price change for the item based on the inventory level of the item and the set of rules; and send the decision to one or more entities. The system may control or update digital shelves, point-to-sale terminals, etc. to help maintain inventory levels.

A method for performing concepts disclosed herein can include: receiving data on an inventory of an item from one or more scanning devices; receiving supply data for the item in a specified period of time; determining an inventory level of the item based on the data and the supply data; receiving a set of rules regulating the item; generating a decision on a price change for the item based on the inventory level of the item and the set of rules; and sending the decision to one or more entities.

A non-transitory computer-readable storage medium configured as disclosed herein can have instructions stored which, when executed by a computing device, cause the computing device to perform operations which include: receiving data on an inventory of an item from one or more scanning devices; receiving supply data for the item in a specified period of time; determining an inventory level of the item based on the data and the supply data; receiving a set of rules regulating the item; generating a decision on a price change for the item based on the inventory level of the item and the set of rules; and sending the decision to one or more entities.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary system of intelligent digital supply and demand pricing, according to one embodiment of the present disclosure;

FIG. 2 illustrates another exemplary system of intelligent digital supply and demand pricing, according to one embodiment of the present disclosure;

FIG. 3 illustrates an exemplary method of intelligent digital supply and demand pricing, according to one embodiment of the present disclosure; and

FIG. 4 illustrates an exemplary computer system that may be used to comprise the above systems in FIGS. 1-2, and to perform the method of FIG. 3.

### DETAILED DESCRIPTION

The disclosed systems, methods, and computer-readable storage media may allow product inventory levels to play a factor in determining real-time pricing. The disclosed systems, methods, and computer-readable storage media may update the entities necessary to reflect the price change, such as electronic inventory labels (ESLs), digital labels, point of sale (POS), soft corporate offer (SCO), website, etc. A layer of messaging and reporting may also be directed by the system, where it informs associates, managers, and department leaders.

The disclosed systems, methods, and computer-readable storage media may continue ongoing monitoring of the product inventory so that the pricing may be further tuned as the inventory changes. The disclosed systems, methods, and computer-readable storage media may receive scans from robots, scans from associates (such as device-UPC scanning), and POS data (such as sales for the day). By receiving this data, an inventory level may be determined, for example, as high, medium, or low inventory level. Once a threshold (e.g. an inventory level) is achieved that requires an action, then the system may consult with the rules engine.

In some embodiments, the system may be scheduled for routine price changes based on events, such as calendar events, etc. When a scheduled price change is achieved, then the system may determine an inventory level, consult with the rules engine, make an action determination, and distribute the action to the necessary entities.

In some embodiments, the disclosed systems, methods, and computer-readable storage media may consider demographics and the disposable income available to customers in an area, which may also play a factor for pricing changes. Also retail store profile and type of customer may further impact the pricing decision.

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth.

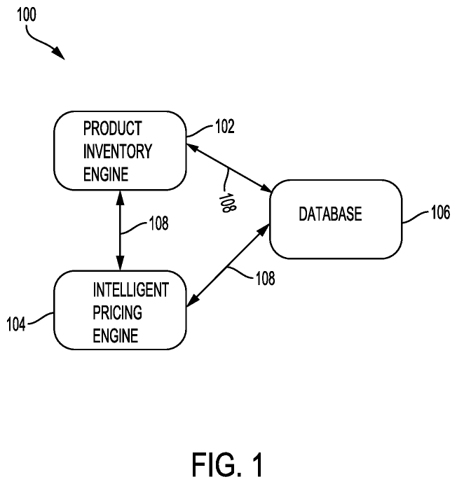

FIG. 1 illustrates an exemplary system 100 according to one embodiment of the present disclosure. The system 100 may comprise a product inventory engine 102, an intelligent pricing engine 104, and one or more database 106. The system 100 may further comprise one or more wired or wireless communication networks 108 through which the product inventory engine 102, the intelligent pricing engine 104, and the database 106 may communicate one another.

The product inventory engine 102, the intelligent pricing engine 104, and the database 106, may each comprise computing hardware, computing software, or a combination thereof to implement the desired functions and features. In addition, the product inventory engine 102, the intelligent pricing engine 104, and the database 106 may embody a server cluster with each of the product inventory engine 102, the intelligent pricing engine 104, and the database 106 operates on one server. The product inventory engine 102, the intelligent pricing engine 104, and the database 106 may embody a cloud computing environment. Further, a portion or whole of the system 100 may be configured to operate by different parties. For example, the product inventory engine 102 and the intelligent pricing engine 104 may be operated by a retail store, and the database 106 may be operated by a cloud computing provider.

The product inventory engine 102 may be configured to receive product data and product scanning information from various sources, for example, the product supplier and product scanning robots or store associates. The scanning information may be scan data on an inventory of an item or product from one or more scanning devices. The one or more scanning devices may comprise a point-of-sale device, a robotic device, or a hand-held device.

The product inventory engine 102 may further be configured to receive supply data on the product in a specified period of time, and determine an inventory level of the product based, at least, on the scan data and the supply data. The inventory level of the product may be a predictive inventory level of the product or a current inventory level of the product.

The intelligent pricing engine 104 may be configured to determine a product inventory level. The intelligent pricing engine 104 may further be configured to make a price change decision on the product based on the determined product inventory level. The intelligent pricing engine 104 may also be configured to consult with a set of rules for making the price change decision. The intelligent pricing engine 104 may also be configured to communicate the price change decisions to various entities, such as a POS.

The one or more database 106 may be configured to receive and store various product information. The database 106 may also be configured to communicate with the product inventory engine 102 and the intelligent pricing engine 104 to provide them the requested information that may be used to analyze the inventory level and make the price change decision.

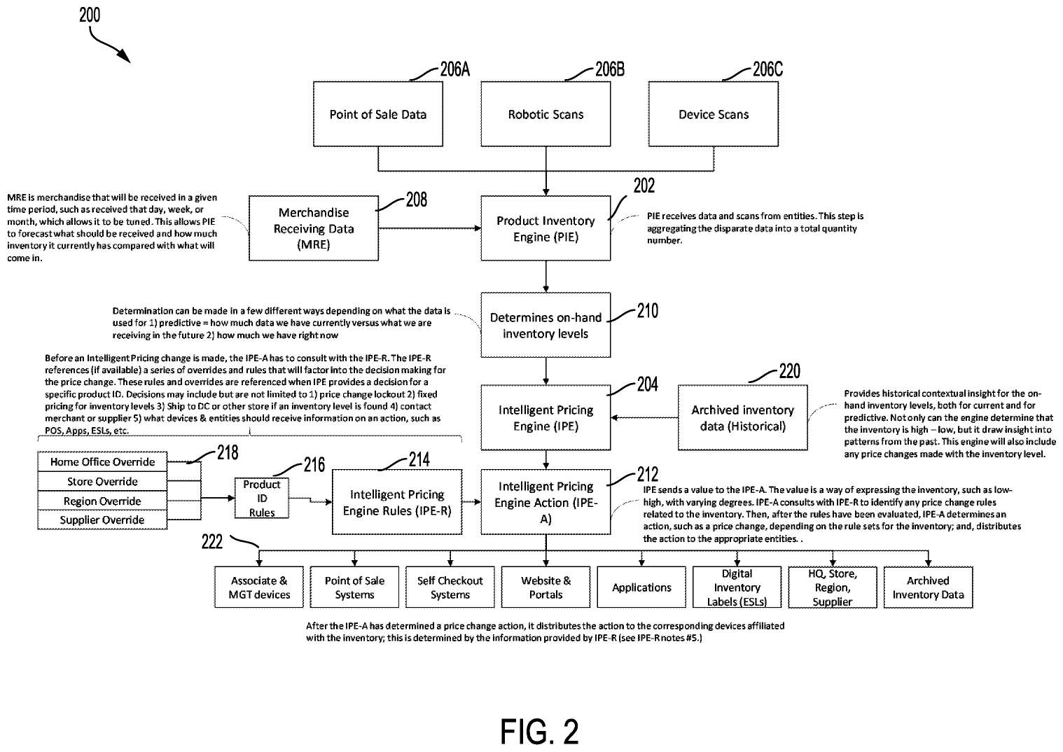

FIG. 2 illustrates another exemplary system 200 according to one embodiment of the present disclosure. The system 200 may comprise a product inventory engine (PIE) 202, and an intelligent pricing engine (WE) 204. The PIE 202 and WE 204 may each comprise computing hardware, computing software, or a combination thereof to implement the desired functions and features.

The PIE 202 may be configured to determine an inventory level of a product. The PIE 202 may receive various data and scans from entities to aggregate the disparate data into a total quantity number for various items. Examples of the entities may include POS 206A, robotic scans 206B, and device scans 206C (e.g., a hand-held barcode scanner by a store associate or a smart tablet scanner by a stock room associate). The inventory level may be determined based on those data. The inventory level may be analyzed and categorized into various levels or categories, such as a low inventory level, a medium inventory level, and a high inventory level. The levels may depend on the item, time period, expected demand, etc.

The PIE 202 may further be configured to receive merchandise receiving data (MRE) from a MRE module 208. The MRE may include merchandise that will be received in a given time period, such as received that day, week, or month, which allows it to be tuned. This may allow the PIE 202 to forecast what should be received and how much inventory it currently has compared with what will come in. The inventory level may be further determined based on the MRE.

The PIE 202 may include an inventory determination module 210 that may be configured to determine on-hand or current inventory level of the product. The determination may be made in a few different ways depending on what the data is used for. For example, the determination may be predictive, that is, how much inventory a store has currently versus what the store is receiving in the future. The determination may also be current, that is, how much the store has right now.

The IPE 204 may be configured to receive the inventory level determined by the PIE 202. Alternatively, the IPE 204 may also be configured to receive processed (e.g., data being categorized) data from the PIE 202, and determine an inventory level based on the processed data.

The IPE 204 may be configured to use an intelligent pricing engine action (IPE-A) module 212 to make an action decision, based, at least, on the determined inventory level. The action may comprise a price change to the product.

In some embodiments, the IPE 204 may consult a set of rules regulating the product from an intelligent pricing engine rules (IPE-R) module 214. Before a change is made, the IPE-A 212 may consult with the IPE-R 214. The IPE-R 214 may reference (if available) a series of overrides and rules that may be factored into the decision making for the price change. These rules and overrides may be referenced when the IPE 204 provides an action decision for a specific product ID via a product ID rules module 216. The rules may specify the various conditions to meet for a price change for each product ID. For example, the rules may specify actions to be taken when a new version of a product is being released, the sales levels have changed, the inventory level has changed, a product expiration date is approaching, etc. The overrides 218 may include home office override, store override, region override, and supplier override.

The action decisions may include, but are not limited to: a price drop, a price increase, a price change lockout, a fixed pricing for the inventory level, contact merchant or supplier of the product, ship to a distribution center or other store if an inventory level is found in the distribution center or the other store, or what devices and entities should receive information on the decision (such as POS, Apps, ESLs, etc.) The decisions may be sent out to one or more entities.

In some embodiments, the IPE 204 may further be configured to receive data on historical inventory levels of the product from an archived inventory data module 220. This historical data may provide historical contextual insight for the current and predictive inventory levels. Not only can the IPE 204 determine that the inventory is high or low, but it may draw insight into inventory patterns from the past. The historical data may also include any price changes made with the historical inventory levels. The decision on the price change for the product, may be based partially on the data of the historical inventory levels of the product.

For example, the recorded data about each iteration can be used to modify the pricing algorithm. For example, the weights assigned to various factors may change based on the selections and patterns made by the system. To modify the pricing algorithm can require modifications to code and/or processor configurations. That is, if the algorithm is being executed by a processor from memory, modification of the algorithm can require overwriting the memory with the new, more efficient code. If the algorithm is encoded into a processor such as an FPGA (Field-Programmable Gate Array), modification of the algorithm can require a modification to the modifiable processor itself.

The entities 222 that receive the action decisions may comprise an associate of a store, a point of sale, a self-checkout device, a website, a portal, an application, a digital inventory label, a headquarter, a region, a store, a supplier, or archived inventory data.

In some embodiments, the PIE module 202 may be further configured to specify a threshold for the inventory level of the product. For example, a threshold may be equal to 20% of a most recent inventory level. The IPE module 204 may be further configured to generate the action decisions on the price change for the product based on the threshold.

In some embodiments, the IPE 204 may further be configured to generate the action decisions on the price change based on calendar events, for example, a holiday celebration. The IPE module 204 may further be configured to generate the action decisions on the price change based on demographics, a store profile, or type of customers. For example, when holiday has passed, the product price may be dropped a certain percentage. When a store is located in a sparsely populated area, the price may be dropped.

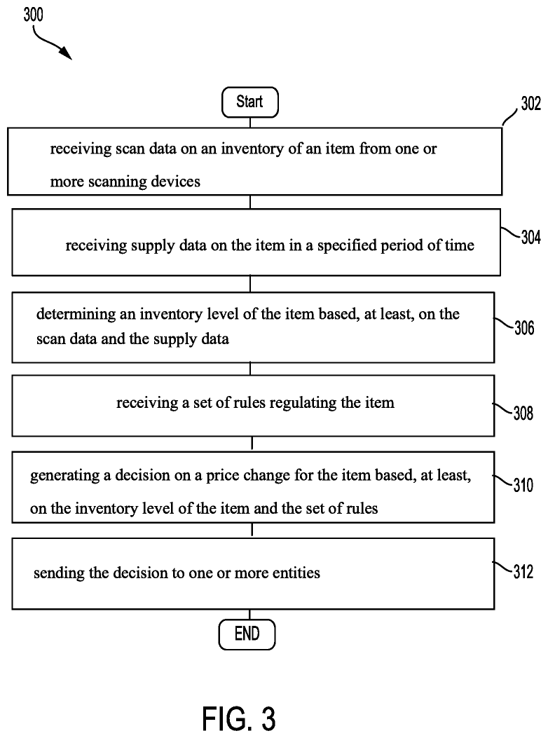

FIG. 3 illustrates an exemplary method 300 according to one embodiment of the present disclosure. The method 300 may be implemented in the above disclosed systems, may include the following steps, and thus some details may not be repeated herein that can refer to the above description of the systems.

At step 302, scan data on an inventory of an item is received from one or more scanning devices, by the PIE 202. The scan data may comprise data scanned at a POS, a shelf checkout station, etc. The scanning devices may include a barcode scanner, a quick response (QR) code scanner, etc.

At step 304, supply data on the item in a specified period of time may be received, by the PIE 202. The supply data may be data indicating that how many items will be supplied during the specified period of time, such as one day, one week, or one month.

At step 306, an inventory level of the item may be determined based, at least, on the scan data and the supply data. The PIE 202 may use an inventory level determination module to calculate the inventory level. The determined inventory level may be a predictive inventory level, or an on-hand inventory level.

At step 308, a set of rules regulating the item may be received, by the PIE 202 or the IPE 204. The set of rules may specify some conditions, terms, or overrides that apply to the item. Such rules and overrides may impact determination of a price change on the item.

At step 310, a decision on a price change for the item may be generated based, at least, on the inventory level of the item, the set of rules, or a combination thereof. Such decision may include, but is not limited to, a fixed price on the item with the determined inventory level, a price drop, a price increase, etc.

The set of rules can be created to prevent surge pricing. For example, in an area where a hurricane is projected to hit, one or more rules may be created to avoid a price surge because of a low inventory.

At step 312, the decision may be sent to one or more entities. The decision may also include what devices or entities the decision should be distributed to. The devices and entities may include a POS, an applications, a website and portals, associates, MGT devices, store managers, item suppliers, etc.

In some embodiments, data on historical inventory levels of the item may also be received. The decision on the price change for the item may be generated, based partially on the data of the historical inventory levels of the item. Such historical inventory levels may provide further insight for the inventory level determination.

In some embodiments, the method 300 may further comprise specifying a threshold for the inventory level of the item, and generating the decision on the price change for the item based on the threshold. For example, the decision may be triggered when the inventory level drops to a 40% of the prior inventory level.

In some embodiments, the method 300 may further comprise generating the decision on the price change based on calendar events. The calendar events may include holiday events, celebration events, special vents, etc.

A non-transitory computer-readable storage medium having instructions stored which, when executed by a computing device, cause the computing device to perform operations comprising: receiving scan data on an inventory of an item from one or more scanning devices; receiving supply data on the item in a specified period of time; determining an inventory level of the item based, at least, on the scan data and the supply data; receiving a set of rules regulating the item; generating a decision on a price change for the item based, at least, on the inventory level of the item and the set of rules; and sending the decision to one or more entities.

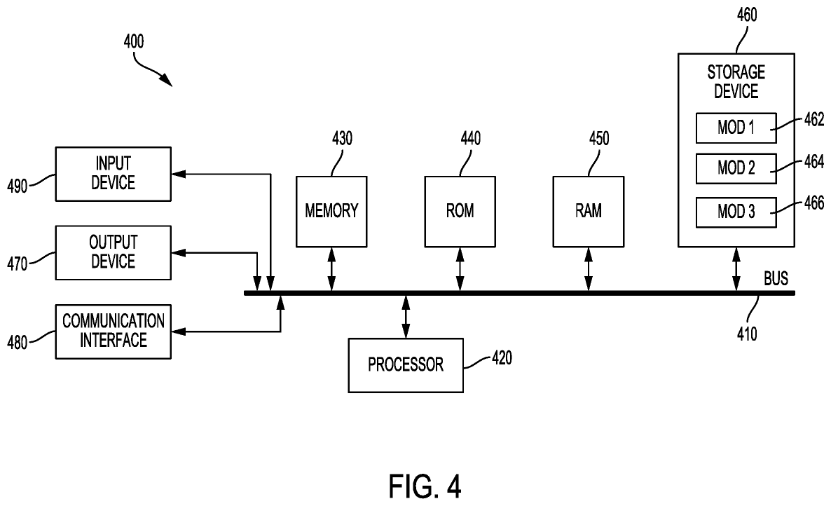

FIG. 4 illustrates an exemplary computer system 400 that may be used to comprise the above systems in FIGS. 1-2, and to perform the method of FIG. 3. The exemplary system 400 can include a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing system 400 with more than one processor 420 or on a group or cluster of computing devices networked together to provide greater processing capability. The processor 420 can include any general purpose processor and a hardware module or software module, such as module 1 462, module 2 444, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing system 400, such as during start-up. The computing system 400 further includes storage devices 460 such as a hard disk drive, a magnetic disk drive, an optical disk drive, tape drive or the like. The storage device 440 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing system 400. In one aspect, a hardware module that performs a particular function includes the software component stored in a tangible computer-readable storage medium in connection with the necessary hardware components, such as the processor 420, bus 410, output device 470 as display, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the system 400 is a small, handheld computing device, a desktop computer, or a computer server.

Although the exemplary embodiment described herein employs the hard disk as the storage device 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing system 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing system 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system, comprising:
a product inventory engine (PIE) module, configured to:
receive data on an inventory of an item from one or more scanning devices;
receive supply data for the item in a specified period of time; and
determine an inventory level of the item based on the data and the supply data, and
an intelligent pricing engine (WE) module, configured to:
receive a set of rules regulating the item;
generate a decision on a price change for the item based on the inventory level of the item and the set of rules; and
send the decision to one or more entities.

2. The system of claim 1, wherein the one or more scanning devices comprise a point-of sale device, a robotic device, or a hand-held device.

3. The system of claim 1, wherein the inventory level of the item is a predictive inventory level of the item or a current inventory level of the item.

4. The system of claim 1, wherein the IPE module is further configured to:
receive data on historical inventory levels of the item; and
generate the decision on the price change for the item, based partially on the data of the historical inventory levels of the item.

5. The system of claim 1, wherein:
the PIE module is further configured to specify a threshold for the inventory level of the item; and
the IPE module is further configured to generate the decision on the price change for the item based on the threshold.

6. The system of claim 1, wherein the set of rules regulating the item comprise a home office override, a store override, a region override, and a supplier override.

7. The system of claim 1, wherein the decision on the price change for the item comprises a price drop, a price increase, a price change lockout, a fixed pricing for the inventory level, contact merchant or supplier of the item, and what devices and entities should receive information on the decision.

8. The system of claim 1, wherein the entities comprise an associate of a store, a point of sale, a self-checkout device, a website, a portal, an application, a digital inventory label, a headquarter, a region, a store, a supplier, or archived inventory data.

9. The system of claim 1, wherein the IPE module is further configured to generate the decision on the price change based on calendar events.

10. The system of claim 1, wherein the IPE module is further configured to generate the decision on the price change based on demographics, a store profile, or type of customers.

11. A method, comprising:
receiving data on an inventory of an item from one or more scanning devices;
receiving supply data for the item in a specified period of time;
determining an inventory level of the item based on the—data and the supply data;
receiving a set of rules regulating the item;
generating a decision on a price change for the item based on the inventory level of the item and the set of rules; and
sending the decision to one or more entities.

12. The method of claim 11, wherein the one or more scanning devices comprise a point-of sale device, a robotic device, or a hand-held device.

13. The method of claim 11, wherein the inventory level of the item is a predictive inventory level of the item or a current inventory level of the item.

14. The method of claim 11, further comprising:
receiving data on historical inventory levels of the item; and
generating the decision on the price change for the item, based partially on the data of the historical inventory levels of the item.

15. The method of claim 11, further comprising:
specifying a threshold for the inventory level of the item; and
generating the decision on the price change for the item based on the threshold.

16. The method of claim 11, wherein the set of rules regulating the item comprise a home office override, a store override, a region override, or a supplier override.

17. The method of claim 11, wherein the decision on the price change for the item comprises a price drop, a price increase, a price change lockout, a fixed pricing for the inventory level, contact merchant or supplier of the item, or what devices and entities should receive information on the decision.

18. The method of claim 11, wherein the entities comprise an associate of a store, a point of sale, a self-checkout device, a website, a portal, an application, a digital inventory label, a headquarter, a region, a store, a supplier, or archived inventory data.

19. The method of claim 1, further comprising generate the decision on the price change based on calendar events.

20. A non-transitory computer-readable storage medium having instructions stored which, when executed by a computing device, cause the computing device to perform operations comprising:
receiving data on an inventory of an item from one or more scanning devices;
receiving supply data for the item in a specified period of time;
determining an inventory level of the item based on the data and the supply data;
receiving a set of rules regulating the item;
generating a decision on a price change for the item based on the inventory level of the item and the set of rules; and
sending the decision to one or more entities.
